(19) United States
(12) Patent Application Publication
(10) Pub. No.: US 2010/0048767 A1
(43) Pub. Date: Feb. 25, 2010

(54) ENVIRONMENTALLY DEGRADABLE POLYMERIC BLEND AND PROCESS FOR OBTAINING AN ENVIRONMENTALLY DEGRADABLE POLYMERIC BLEND

(75) Inventors: Jefter Fernandes Nascimento, Sao Paulo City (BR); Wagner Mauricio Pachekoski, Sao Carlos - SP (BR); Jose Augusto Marcondes Agnelli, Sao Carlos - SP (BR)

Correspondence Address: DARBY & DARBY P.C., P.O. BOX 770, Church Street Station, New York, NY, 10008-0770, US

(73) Assignee: PHB INDUSTRIAL S.A., Serrana - SP (BR)

(21) Appl. No.: 12/280,441

(22) PCT Filed: Feb. 23, 2007
(86) PCT No.: PCT/BR07/00043

§ 371 Date: Mar. 16, 2009

(30) Foreign Application Priority Data
Feb. 24, 2006 (BR) PI0600685-0

(51) Int. Cl. C08L 97/02; C08L 33/06

(52) U.S. Cl. 524/35; 524/502

(57) ABSTRACT

The present invention refers to a polymeric blend for the preparation of environmentally degradable materials, said blend comprising biodegradable polymers, polyhydroxybutyrate—PHB or copolymers thereof and poly(butylene adipate/butylene terephthalate) aliphatic-aromatic copolyester and at least one additive. The present invention further refers to the process for obtaining said blend, by applying the extrusion technique to obtain an adequate morphology in the distribution, dispersion and interaction of the polymers, so as to obtain compatible polymeric blends, allowing the granules of the produced polymeric blends to be utilized to manufacture several injection molded products.

### FIELD OF THE INVENTION

The present invention refers to a polymeric blend based upon a biodegradable polymer defined by polyhydroxybutyrate or copolymers thereof and an aliphatic copolyester, and at least one additive, such as a filler, a nucleant, a thermal stabilizer, a processing aid additive, with the objective of preparing an environmentally degradable polymeric blend.

According to the process described herein, the blend resulting from the mixture of the biodegradable polymer with an aromatic aliphatic copolyester and additives, can be used in the manufacture of food packages, due to improved results obtained with this composition and to the fact that it can be discarded as a compost without causing problems to the environment.

### PRIOR ART

There are known from the prior art different biodegradable polymeric materials used for manufacturing garbage bags and/or packages, comprising a combination of degradable synthetic polymers and additives, which are used to improve the obtention and/or properties thereof, ensuring a wide application.

Polymeric blend is the term adopted in the technical literature about polymers to represent the physical or mechanical mixtures of two or more polymers, so that between the molecular chains of the different polymers only exists secondary intermolecular interaction or in which there is not a high degree of chemical reaction between the molecular chains of the different polymers. Many polymeric blends are used as engineering plastics, with applications mainly in the automobilistic and electromechanical industries, and in countless other industrial fields. Among the polymers that form these polymeric blends, it is highly predominant the use of conventional polymers.

Recently, it has been noticed the increasing interest in employing biodegradable polymers, i.e. polymers that are environmentally correct. However, most patents of biodegradable polymers refer to the production of polymers, and only a small number relates to the application thereof in polymeric blends and the biodegradability of these new polymeric materials.

In the attempt of creating alterations in the characteristics of processability and/or mechanical properties, some modifications of the polyhydroxybutyrate PHB have been proposed, such as the formation of polymeric blends with other biodegradable polymers, associated or not with other possibilities of additivation. Such developments are often carried out in laboratory processes and/or use manual molding techniques, without industrial productivity.

Accordingly, some citations have been found regarding miscible and compatible polymeric blends, formed by PHB with the polymers: polyvinylacetate—PVAc, polyepichloroidrine—PECH, polyvinylydene fluoride—PVDF, poly(R,S) 3-hydroxybutyrate copolymer, polyethylene glycol—P(R,S-HB-b-EG), and polymethylmethacrylate—PMMA. There are also citations of unmiscible and compatible polymeric blends, based on the mixture of PHB with: poly(1,4 butylene adipate)—PBA, ethylpropylene rubbers (EPR); ethylenevinylacetate (EVA), modified EPR (grafted with succinic anhydride (EPR-g-SA) or with dibutyl maleate (EPR-DBM)), modified EVA containing —OH group (EVAL) and polycyclo-hexyl methacryilate—PCHMA, poly(lactic acid)—PLA and polycaprolactone—PCL. On the other hand, no citations were found about polymeric blends formed by the pair defined by PHB—aliphatic-aromatic Copolyester Ecoflex, which gives a novel character to the invention in the following aspects:
technology of obtaining compatible polymeric blends based on the PHB—Copolyester Ecoflex aliphatic-aromatic pair.
possibility of greatly varying the contents of the constitutive polymers, producing tailored polymeric materials from intrinsic characteristics of these components, the dispersion and distribution of the polymers permit the formation of an adequate and stable morphology, resulting in polymeric blends with a satisfactory performance.
possibility of modifying these polymeric blends with other additives, such as natural fibers and natural fillers and lignocellulosic residues.
utilization of two methods with commercial viability: extrusion process for obtaining the polymeric blends and injection molding for obtaining products.

### SUMMARY OF THE INVENTION

It is a generic object of the present invention to provide a polymeric blend to be used in different applications, such as for example, in the manufacture of injected food packages, injected packages for cosmetics, tubes, technical pieces and several injected products, by using a biodegradable polymer defined by polyhydroxybutyrate or copolymers thereof; a poly aliphatic aromatic copolyester and at least one additive, thus allowing the production of environmentally degradable materials.

According to a first aspect of the invention, there is provided a polymeric blend, comprising a biodegradable polymer defined by polyhydroxybutyrate or copolymers thereof; an aliphatic-aromatic copolyester; and, optionally, at least one additive consisting of: plasticizer of natural origin, such as natural fibers; natural fillers; thermal stabilizer; nucleant; compatibilizer; surface treatment additive; and processing aid.

In accordance with a second aspect of the present invention, a process is provided for preparing the blend described above, comprising the steps of:

a) pre-mixing the materials that constitute the formulation of interest; b) drying said materials; extruding the pre-mixed materials to obtain granulation; and c) injection molding the extruded and granulated material to manufacture the injected packages, as well as other injected products.

### BRIEF DESCRIPTION OF THE DRAWINGS

FIG. 1a is a photograph of the biodegradation essay in soil (ASTM D 6003 and ASTM G160) of the polymeric blend with 75% PHB, 25% aliphatic aromatic copolyester and 30% of wood dust in contact with the soil in time zero;

FIG. 1b is a photograph of the blend, illustrating its degradation after 30 days in contact with the soil;

FIG. 1c is a photograph of the blend, illustrating its degradation after 60 days; and

FIG. 1d is a photograph of the blend, illustrating its degradation after 90 days;

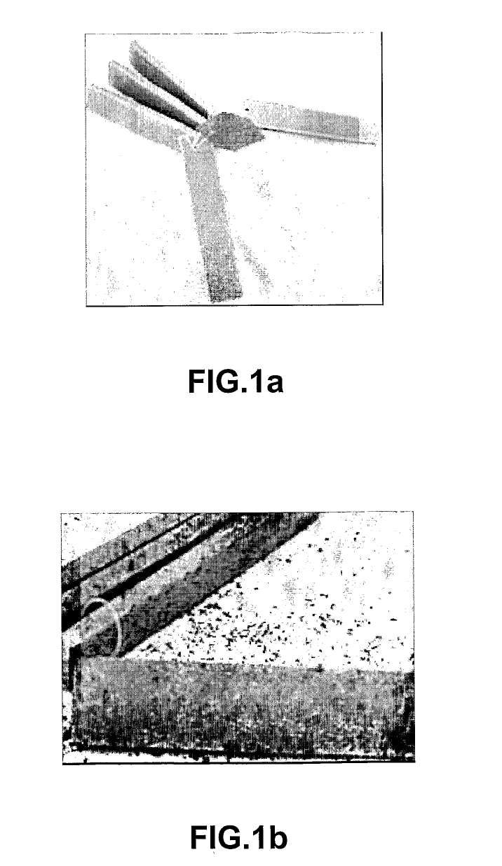

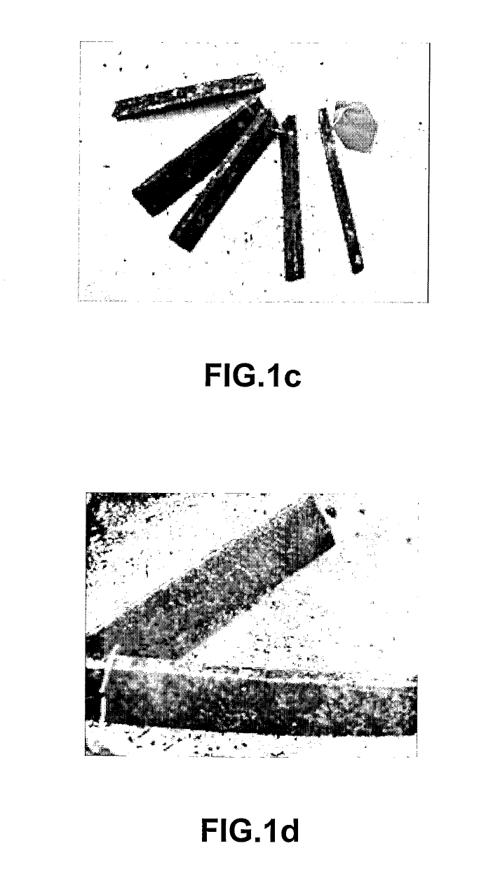

### DETAILED DESCRIPTION OF THE INVENTION

Within the class of biodegradable polymers, the structures containing ester functional groups are of great interest, mainly due to its usual biodegradability and versatility in physical, chemical and biological properties. Produced by a large variety of microorganisms as a source of energy and carbon, the polyalkanoates (polyesters derived from carboxylic acids) can be synthesized either by biological fermentation or chemically.

Polyhydroxybutyrate—PHB is the main member of the class of polyalkanoates. Its great importance is justified by the reunion of 3 major factors: it is 100% biodegradable, water resistant and also a thermoplastic polymer, allowing it to be used in the same applications as the conventional thermoplastic polymers. Structural formula of (a) 3-hydroxybutyric acid and (b) Poly(3-hydroxybutyric acid)—PHB.

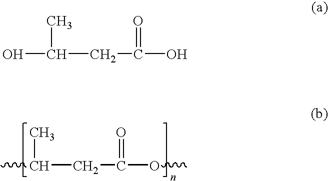

PHB was discovered by Lemognie in 1925 as a source of energy and of carbon storage in microorganisms, such as bacteria Alcaligenis euterophus, in which, under optimum conditions, above 80% of the dry weight is PHB. Nowadays, the bacterial fermentation is the major production source of polyhydroxybutyrate, in which the bacteria are fed in reactors with butyric acid or fructose and left to grow, and after some time the bacterial cells are extracted from PHB with a suitable solvent.

In Brazil, PHB is produced in industrial scale by PHB Industrial S/A, the only Latin America Company that produces polyhydroxyalkanoates (PHAs) from renewable sources. The production process of the polyhydroxybutyrate basically consists of two steps:
Fermentative step: in which the microorganisms metabolize the sugar available in the medium and accumulate the PHB in the interior of the cell as source of reserve.
extraction step: in which the polymer accumulated in the interior of the microorganism cell is extracted and purified until a solid and dry product is obtained.

The project developed by PHB Industrial S.A allowed to use sugar and/or molass as a basic component of the fermentative medium, fusel oil (organic solvent—byproduct of the alcohol manufacture) as extraction system of the polymer synthesized by the microorganisms, and also the use of the excess sugarcane bagasse to produce energy (vapor generation) for these processes.

This project permitted a perfect vertical integration with the maximum utilization of the byproducts generated in the sugar and alcohol manufacture, providing processes that utilize the so-called clean and ecologically correct technologies.

Through a process of production similar to that of the PHB, it is possible to produce a semicrystalline bacterial copolymer of 3-hydroxybutyrate with random segments of 3-hydroxyvalerate, known as PHBV. The main difference between both processes is based on the addition of the proprionic acid in the fermentative medium. The quantity of proprionic acid in the bacteria feeding is responsible for the control of hydroxyvalerate—PHV concentration in the copolymer, enabling to vary the degradation time (which can be from some weeks to several years) and certain physical properties (molar mass, crystallinity degree, surface area, for example). The composition of the copolymer further influences the melting point (which can range from 120 to 180° C.), and the characteristics of ductility and flexibility (which are improved with the increase of HV concentration) Formula 2 presents the basic structure of PHBV.

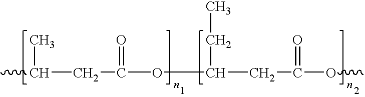

According to some studies, the PHB shows a behavior with some ductility and maximum elongation of 15%, tension elastic modulus of 1.4 GPa and notched IZOD impact strength of 50 J/m soon after the injection of the specimens. Such properties modify as time goes by and stabilize in about one month, with the elongation reducing from 15% to 5% after 15 days of storage, reflecting the fragilization of the material. The tension elastic modulus increases from 1.4 GPa to 3 GPa, while the notched Izod impact strength reduces from 50 J/m to 25 J/m after the same period of storage. Table 1 presents some properties of the PHB compared to the isostatic Polypropylene (commercial polypropylene).

TABLE 1
Comparison of the PHB and the PP properties.

| Properties | PHB | PP |
|---|---|---|
| % of crystallinity degree | 80 | 70 |
| Average Molar mass (g/mol) | 4 × 10⁵ | 2 × 10⁵ |
| Melting Temperature (° C.) | 175 | 176 |
| Glass Transition Temperature | −5 | −10 |
| (° C.) | | |
| Density (g/cm³) | 1.2 | 0.905 |
| Modulus of Flexibility (GPa) | 1.4-3.5 | 1.7 |
| Tensile strength (MPa) | 15-40 | 38 |
| % of Elongation at break | 4-10 | 400 |
| UV Resistance | good | poor |
| Solvent Resistance | poor | Good |

Of great relevance for the user of articles made of PHB or its Poly(3-hydroxybutyric-co-hydroxyvaleric acid)—PHBV copolymers are the degradation rates of these articles under several environmental conditions. The reason that makes them acceptable as potential biodegradable substitutes for the synthetic polymers is their complete biodegradability in aerobic and anaerobic environments to produce CO₂/H₂O/biomass and CO₂/H₂O/CH₄/biomass, respectively, through natural biological mineralization. This biodegradation usually occurs via surface attack by bacteria, fungi and algae. The actual degradation time of the biodegradable polymers and, therefore, of the PHB and PHBV, will depend upon the surrounding environment, as well as upon the thickness of the articles.

PHB or PHBV may or may not contain plasticizers of natural origin, specifically developed for plasticizing these biodegradable polymers.

The plasticizing additive can be a vegetable oil “in natura” (as found in nature) or derivative thereof, ester or epoxy, from soybean, corn, castor-oil, palm, coconut, peanut, linseed, sunflower, babasu palm, palm kernel, canola, olive, carnauba wax, tung, jojoba, grape seed, andiroba, almond, sweet almond, cotton, walnuts, wheatgerm, rice, macadamia, sesame, hazelnut, cocoa (butter), cashew nut, cupuacu, poppy and their possible hydrogenated derivatives, being present in the blend composition in a mass proportion lying from about 2% to about 30%, preferably from about 2% to about 15% and more preferably from about 5% to about 10%.

Said plasticizer further presents a fatty composition ranging from: 45-63% of linoleates, 2-4% of linoleinates, 1-4% of palmitates, 1-3% of palmitoleates, 12-29% of oleates, 5-12% of stearates, 2-6% of miristates, 20-35% of palmistate, 1-2% of gadoleates and 0.5-1.6% of behenates.

Aliphatic-Aromatic poly(butylene adipate/butylene terephthalate)Copolyester

The Aliphatic-Aromatic poly(butylene adipate/butylene terephthalate)Copolyester is a completely biodegradable polymer produced by BASF AG under the trademark “Ecoflex®”. It is a polymer useful for garbage bags or packages. The aliphatic-aromatic copolyester decomposes in the soil or becomes composted within weeks, without leaving any residues. BASF introduced this thermoplastic polymer in the market in 1998, and after eight years, it has become a biodegradable synthetic material commercially available worldwide. When mixed with other degradable materials based upon renewable resources, such as PHB, the aliphatic-aromatic copolyester is highly satisfactory for producing food packages, particularly for packaging food articles to be frozen. Formula 3 shows the representation of the chemical structure of the copolyester, where M indicates the modular components which work as chain extenders. Chemical structure of the polymers that form the macromolecules of the aliphatic-aromatic poly(butylene adipate/butylene terephthalate)copolyester—ECOFLEX.

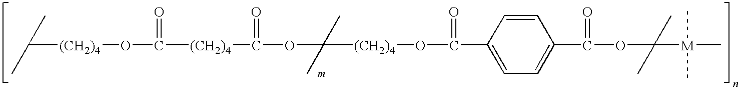

The aliphatic-aromatic copolyester has adequate qualities for food packages, since it retains the freshness, taste and aroma in hamburger boxes, snack trays, coffee disposable cups, packages for meat or fruit and fast-food packages. The material improves the performance of these products, complying with the food legislation requirements.

The polymer is water-resistant, tear-resistant, flexible, allows printing thereon and can be thermowelded. In combinations with other biodegradable polymers, the polymeric blends have the advantage of being composted, presenting no problems.

Modifiers and Other Additives that Can Be Incorporated in the PHB/aliphatic-Aromatic Copolyester Blends
Natural fibers: the natural fibers that can be used in the developed process herein are: sisal, sugarcane bagasse, coconut, piasaba, soybean, jute, ramie, and curaua (Ananas lucidus), in a proportion ranging from about 5% to about 70% and, more preferably, from about 10% to about 60%.
Natural fillers: the lignocellulosic fillers that can be used in the developed process are: wood flour (or wood dust), starches and rice husk, in a proportion ranging from about 5% to about 70% and, more preferably, from about 10% to about 60%.
Processing aid/dispersant: optional utilization of processing aid/dispersant specific for compositions with thermoplastics, present in a mass proportion from about 0.01% to about 2%, preferably from about 0 .05% to about 1% in relation to the total content of modifiers. The processing aid additive may be defined by the product “Struktol”, commercialized by Struktol Company of America
Nucleants: boron nitride or HPN®, from Milliken.
compatibilizers selected from: polyolefin, functionalized or grafted with maleic anhydride; ionomer based on ethylene acrylic acid or ethylene methacrylic acid neutralized with sodium, present in a mass proportion lying from about 0.01% to about 2%, preferably from about 0.05% to about 1%.
surface treatment additives selected from: silane; titanate; zirconate; epoxy resin; stearic acid and calcium stearate, present in a mass proportion lying from about 0.01% to about 2%.

Other additives of optional use: thermal stabilizers-primary antioxidant and secondary antioxidant, pigments, ultraviolet stabilizers of the oligomeric HALS type (sterically hindered amine)

Production Process of the Polymeric Blends Developed Methodology and Formulations of the Polymeric Blends

The generalized methodology developed for the preparation of the PHB/aliphatic-aromatic Copolyester polymeric blends is based on five steps, which can be compulsory or not, depending upon the specific objective desired for a particular biodegradable mixture.

The steps for preparing the PHB/aliphatic-aromatic Copolyester polymeric blends are:

a. Defining the formulations

b. Drying both the biodegradable polymers and the other optional components

c. Pre-mixing the components

d. Extruding and granulating

e. Injection molding for the manufacture of several products

Description of the Steps

a. Defining the Formulations:

Table 2 presents the main formulations of the PHB/aliphatic-aromatic copolyester polymeric blends.

Formulations of the PHB/aliphatic-aromatic copolyester polymeric blends, including the modifiers and other optional additives.

TABLE 2

| | Content range |
|---|---|
| COMPONENTS | (% in MASS) |
| Biodegradable polymer 1: PHB or | 10 a 90% |
| PHBV, containing or not up to 6% of | |
| plasticizer of natural origin | |
| Biodegradable polymer 2: Aliphatic- | 10 a 90% |
| aromatic poly (butyleneadipate/ | |
| butylene terephthalate) copolyester | |
| Natural fiber 1* | 0 a 30% |
| Natural fiber 2** | |
| Lignocellulosic filler*** | 0 a 30% |
| Processing aid/Dispersant/ | 0 a 0.5% |
| Nucleant | |
| Thermal stabilization system - | 0 a 0.3% |
| Primary antioxidant:secondary | |
| antioxidant (1:2) | |
| Pigments | 0 a 2.0% |
| Ultraviolet stabilizers | 0 a 0.2% |

*sisal or sugarcane bagasse or coconut or piasaba or soybean or jute or ramie or curaua (Ananas lucidus)
**any of the natural fibers employed, except the fiber selected as natural fiber 1.
***wood flour, starches or rice husk (or straw).

b. Drying the Biodegradable Polymers and the Other Optional Components

The biodegradable polymers PHB, the aliphatic-aromatic copolyester and other possible modifiers should be adequately dried prior to the processing operations that will result in the production of the polymeric blends.

The residual moisture content should be quantified by Thermogravimetry or other equivalent analytical technique.

c. Pre-Mixing the Components

Biodegradable polymers and other optional additives, except the fiber(s), can be physically premixed and homogenized in mixers of low rotation, at room temperature.

d. Extruding and Granulating

The extrusion process is responsible for the structural formation of the PHB/aliphatic-aromatic copolyester polymeric blends. That is to say, the obtention of the morphology of the polymeric system, including distribution, dispersion and interaction of the biodegradable polymers is defined in this step of the process. In the extrusion step, granulation of the developed materials also occurs.

In the extrusion step it is necessary to use a modular co-rotating twin screw extruder with intermeshing screws, from Werner & Pfleiderer or the like, containing gravimetric feeders/dosage systems of high precision.

The main strategic aspects of the distribution, dispersion, and interaction of the biodegradable polymers in the polymeric blend are: the development of the profile of the modular screws, considering the rheologic behavior of both the PHB and the aliphatic-aromatic copolyester; the feeding place of the optional natural modifiers; the temperature profile; the extruder flowrate.

The profile of the modular screws, i.e., the type, number, distribution sequence and adequate positioning of the elements (conveying and mixing elements) determine the efficiency of the mixture and consequently the quality of the polymeric blend, without causing a processing severity that might provoke degradation of the constituent polymers.

Modular screw profiles were used with pre-established formulations of conveying elements controlling the pressure field and kneading elements for controlling both the melting and the mixture (dispersion and distribution of the biodegradable polymers). These groups of elements are vital factors to achieve an adequate morphological control of the structure, optimum dispersion and satisfactory distribution of both PHB and aliphatic-aromatic copolyester.

The optional natural modifiers can be introduced directly into the feed hopper of the extruder and/or in an intermediary position (fifth barrel), with the PHB and aliphatic-aromatic copolyester polymers already in the melted state.

The temperature profile of the different heating zones, notably the feeding region and the head region at the outlet of the extruder, as well as the flowrate controlled by the rotation speed of the screws are also highly important variables.

Table 3 shows the processing conditions through extrusion for the compositions of the PHB/aliphatic-aromatic copolyester polymeric blends.

The granulation for obtaining the granules of the PHB/aliphatic-aromatic copolyester polymeric blends is carried out in common granulators, which however can allow an adequate control of the speed and number of blades so that the granules present dimensions so that allow achieving a high productivity in the injection molding.

TABLE 3
Extrusion conditions for obtaining the PHB/aliphatic-
aromatic copolyester polymeric blends
PHB/aliphatic-aromatic Copolyester Polymeric blends

| Temperature (° C.) | | | | | | | |
|---|---|---|---|---|---|---|---|
| Zone | Zone | Zone | Zone | Zone | Zone | | Speed |
| 1 | 2 | 3 | 4 | 5 | 6 | Head | (rpm) |
| 120-150 | 125-150 | 140-170 | 150-175 | 150-175 | 150-175 | 150-175 | 140-200 |

e. Injection Molding for the Manufacture of Several Products

In the injection molding it is necessary the utilization of an injecting machine operated through a computer system to effect a strict control on the critical variables of this processing method.

Table 4 shows the processing conditions through injection for the compositions of the PHB/aliphatic-aromatic copolyester polymeric blends.

The integration of the injection molding in the developed process is satisfactorily obtained by controlling the critical variables: melt temperature, screw speed during the dosage and counter pressure. If there is not a severe control of said variables (conditions presented in Table 4), the high shearing inside the gun will give rise to the formation of gases, hindering the uniformization of the dosage, jeopardizing the filling operation of the cavities.

Special attention should also be given to the project of the molds, mainly relative to the dimensional aspect, when using the molds with hot chambers, in order to maintain the polymeric blend in the ideal temperature, and when using submarine channels, as a function of the high shearing resulting from the restricted passage to the cavity.

TABLE 4
Injection conditions of the PHB/aliphatic-aromatic
copolyester polymeric blends

| | Feeding | Zone 2 | Zone 3 | Zone 4 | Zone 5 | ° C. |
|---|---|---|---|---|---|---|
| Thermal | 155-165 | 165-175 | 165-175 | 165-175 | 165-170 | |
| Profile | | | | | | |

| | PHB/aliphatic-aromatic | |
|---|---|---|
| Material | copolyester polymeric blends | |
| Injection Pressure | 450-800 | bar |
| Injection Speed | 20-40 | cm³/s |
| Commutation | 450-800 | bar |
| Packing pressure | 300-550 | bar |
| Packing time | 10-15 | s |
| Dosage speed | 8-15 | m/min |
| Counter pressure | 10-60 | bar |
| Cooling time | 20-35 | s |
| Mold temperature | 20-40 | ° C. |

Examples of Properties Obtained for Some Compositions of the Poly(hydroxybutyrate)—PHB/Aliphatic-Aromatic Copolyester Polymeric Blends

There are listed below examples of polymeric blends consisting of Poly(hydroxybutyrate)-HB/poly(butylene adipate/butylene terephthalate) Aliphatic-aromatic copolyester ECOFLEX, whereas Tables 5-9 present the characterization of these polymeric blends:

### Example 1

Polymeric blend of 60% plasticized Poly(hydroxybutyrate)-PHB/40% poly(butylene adipate/butylene terephthalate) Aliphatic-aromatic copolyester ECOFLEX (Table 5).

### Example 2

Polymeric blend of 70% plasticized Poly(hydroxybutyrate)-PHB/30% poly(butylene adipate/butylene terephthalate) Aliphatic-aromatic copolyester ECOFLEX (Table 6).

### Example 3

Polymeric blend of 80% plasticized Poly(hydroxybutyrate)-PHB/20% poly(butylene adipate/butylene terephthalate Aliphatic-aromatic copolyester) ECOFLEX (Table 7).

### Example 4

Polymeric blend of 60% Poly(hydroxybutyrate)-PHB/20% poly(butylene adipate/butylene terephthalate) Aliphatic-aromatic copolyester ECOFLEX, modified with 20% wood dust or wood flour (Table 8).

### Example 5

Polymeric blend of 70% plasticized Poly(hydroxybutyrate)-PHB/10% poly(butylene adipate/butylene terephthalate) Aliphatic-aromatic copolyester ECOFLEX, reinforced with 20% sisal fibers (Table 9).

TABLE 5
Properties of the polymeric blend of 60% plasticized
PHB/40% Aliphatic-aromatic copolyester

| | Property/Test | (Test method) | (Value) | |
|---|---|---|---|---|
| 1 | Melt flow Index (MFI) | ISSO 1133, | 50 | g/10 min |
| | | 230° C./2.160 g | | |
| 2 | Density | ISO 1183, A | 1.22 | g/cm³ |
| 3 | Tensile strength at | ISO 527.5 mm/min | 14 | MPa |
| | yield | | | |
| | Tensile modulus | ISO 527.5 mm/mim | 660 | MPa |
| | Elongation at break | ISO 527.5 mm/min | 8% | |
| 5 | Izod Impact strength, | ISO 180/1A | 42 | J/m |
| | notched | | | |

TABLE 6
Properties of the polymeric blend of 70% plasticized
PHB/30% Aliphatic-aromatic copolyester

| | Property/Test | Test method | Value | |
|---|---|---|---|---|
| 1 | Melt flow Index (MFI) | ISO 1133, | 45 | g/10 min |
| | | 230° C./2.160 g | | |
| 2 | Density | ISSO 1183, A | 1.22 | g/cm³ |
| 3 | Tensile strength at | ISO 527.5 mm/min | 15 | MPa |
| | yield | | | |
| | Tensile modulus | ISO 527.5 mm/mim | 820 | MPa |
| | Elongation at break | ISO 527.5 mm/min | 7% | |
| 5 | Izod Impact strength, | ISO 180/1A | 52 | J/m |
| | notched | | | |

TABLE 7
Properties of the polymeric blend of 80% plasticized
PHB/20% Aliphatic-aromatic copolyester

| | Property/Test | Test method | Value | |
|---|---|---|---|---|
| 1 | Melt flow Index - | ISO 1133, | 40 | g/10 min |
| | MFI | 230° C./2.160 g | | |
| 2 | Density | ISO 1183, A | 1.22 | g/cm³ |
| 3 | Tensile strength | ISO 527.5 mm/min | 21 | MPa |
| | at yield | | | |
| | Tensile modulus | ISO 527.5 mm/mim | 1.300 | MPa |
| | Elongation at | ISO 527.5 mm/min | 6.5% | |
| | break | | | |
| 5 | Izod Impact | ISO 180/1A | 44 | J/m |
| | strength, notched | | | |

TABLE 8
Properties of the polymeric blend of 60% PHB/20% Aliphatic-aromatic
copolyester, modified with 20% wood dust

| | Property/Test | Test method | Value | |
|---|---|---|---|---|
| 1 | Melt flow Index - | ISO 1133, | 17 | g/10 min |
| | MFI | 230° C./2.160 g | | |
| 2 | Density | ISO 1183, A | 1.24 | g/cm |
| 3 | Tensile strength | ISO 527.5 mm/min | 14 | MPa |
| | at yield | | | |
| | Tensile modulus | ISO 527.5 mm/mim | 1.860 | MPa |
| | Elongation at | ISO 527.5 mm/min | 3% | |
| | break | | | |
| 5 | Izod Impact | ISO 180/1A | 37 | J/m |
| | strength, notched | | | |

TABLE 9
Properties of the polymeric blend of 70%
plasticized PHB/10% Aliphatic-aromatic copolyester,
reinforced with 20% sisal fibers

| | Property/Test) | Test method | Value | |
|---|---|---|---|---|
| 1 | Melt flow Index - | ISO 1133, | 15 | g/10 min |
| | MFI | 230° C./2.160 g | | |
| 2 | Density | ISO 1183, A | 1.24 | g/cm³ |
| 3 | Tensile strength | ISO 527.5 mm/min | 20 | MPa |
| | at yield | | | |
| | Tensile modulus | ISO 527.5 mm/min | 3.000 | MPa |
| | Elongation at | ISO 527.5 mm/min | 3% | |
| | break | | | |
| 5 | Izod Impact | ISO 180/1A, 23° C. | 72 | J/m |
| | strength, notched | ISO 180/1A, −30° C. | 55 | J/m |
| 6 | Heat deflection | ISO 75, 0.45 MPa | 140° | C. |
| | temperature - HDT | | | |

What is claimed:

1. Environmentally degradable polymeric blend, comprising:
a biodegradable polymer, defined by polyhydroxybutyrate (PHB) or copolymers thereof;
a poly(butylene adipate/butylene terephthalate) aliphatic-aromatic copolyester; and
optionally, at least one of the additives comprising: plasticizer of natural origin, such as natural fibers; natural fillers; thermal stabilizer; nucleant; compatibilizer; surface treatment additive; and processing aid additive.

2. Polymeric blend, according to claim 1, wherein the plasticizing additive is a vegetable oil “in natura” (as found in nature) or derivative thereof, ester or epoxy, from soybean, corn, castor-oil, palm, coconut, peanut, linseed, sunflower, babasu palm, palm kernel, canola, olive, carnauba wax, tung, jojoba, grape seed, andiroba, almond, sweet almond, cotton, walnuts, wheatgerm, rice, macadamia, sesame, hazelnut, cocoa (butter), cashew nut, cupuacu, poppy and their possible hydrogenated derivatives, being present in the blend composition in a mass proportion lying from about 2% to about 30%, preferably from about 2% to about 15% and, more preferably, from about 5% to about 10%.

3. Polymeric blend, according to claim 2, wherein the plasticizer comprises a fatty composition ranging from: 45-63% of linoleates, 2-4% of linoleinates, 1-4% of palmitates, 1-3% of palmitoleates, 12-29% of oleates, 5-12% of stearates, 2-6% of miristates, 20-35% of palmistate, 1-2% of gadoleates and 0.5-1.6% of behenates.

4. Polymeric blend, according to claim 1, wherein the natural fibers utilized are selected from sisal, sugarcane bagasse, coconut, piasaba, soybean, jute, ramie, and curaua (Ananas lucidus), in a mass proportion ranging from about 5% to about 70% and, more preferably, from about 103% to about 60%.

5. Polymeric blend, according to claim 1, wherein the lignocellulosic or natural filler additive is selected from: wood flour or wood dust, starches and rice husk, in a proportion lying from about 5% to about 70% and, more preferably, from about 10% to about 60%.

6. Polymeric blend, according to claim 1, wherein the compatibilizing additive is selected from the group consisting of: polyolefin, functionalized or grafted with maleic anhydride; ionomer based on ethylene acrylic acid or ethylene methacrylic acid neutralized with sodium; present in a mass proportion lying from about 0.01% to about 2%, preferably from about 0.05% to about 1%.

7. Polymeric blend, according to claim 1, wherein the surface treatment additive is selected from the group consisting of: silane; titanate; zirconate; epoxy resin; stearic acid and calcium stearate, present in a mass proportion lying from about 0.01% to about 2%.

8. Polymeric blend, according to claim 1, wherein the processing aid additive is the product “Struktol” (commercialized by Struktol Company of America), present in a mass proportion lying from about 0.01% to about 2%, preferably from about 0.05% to about 1%.

9. Polymeric blend, according to claim 1, wherein the stabilizing additive is selected from the group consisting of: primary antioxidant or ultraviolet stabilizer of the oligomeric HALS type (sterically hindered amine), present in a mass proportion lying from about 0.01% to about 2%, preferably from about 0.05% to about 1% and, more preferably, from about 0.1% to about 0.5%.

10. Process for obtaining an environmentally degradable polymeric blend, formed by polyhydroxybutyrate or copolymers thereof; poly(butylene adipate/butylene terephthaiate) aliphatic-aromatic copolyester; and, optionally, at least one of the additives defined by: plasticizer of natural origin, such as natural fibers; natural fillers; thermal stabilizer; nucleant; compatibilizer; surface treatment additive; and processing aid, said process comprising the steps of:
a) pre-mixing the materials that constitute the formulation of interest;
b) drying said materials; extruding the pre-mixed materials to obtain their granulation; and
c) injection molding the extruded and granulated material to manufacture injected packages, as well as other injected products.

11. Use of the polymeric blend, comprising polyhydroxybutyrate, poly(butylene adipate/butylene terephthalate) aliphatic-aromatic copolyester, as defined in claim 1, wherein it is used for manufacturing injected packages for food products, injected packages for cosmetics, tubes, technical pieces and several injected products.

12. Use of the polymeric blend, comprising polyhydroxybutyrate, poly(butylene adipate/butylene terephthalate) aliphatic-aromatic copolyester, as defined claim 2, wherein it is used for manufacturing injected packages for food products, injected packages for cosmetics, tubes, technical pieces and several injected products.

13. Use of the polymeric blend, comprising polyhydroxybutyrate, poly(butylene adipate/butylene terephthalate) aliphatic-aromatic copolyester, as defined in claim 3, wherein it is used for manufacturing injected packages for food products, injected packages for cosmetics, tubes, technical pieces and several injected products.

14. Use of the polymeric blend, comprising polyhydroxybutyrate, poly(butylene adipate/butylene terephthalate) aliphatic-aromatic copolyester, as defined in claim 4, wherein it is used for manufacturing injected packages for food products, injected packages for cosmetics, tubes, technical pieces and several injected products.

15. Use of the polymeric blend, comprising polyhydroxybutyrate, poly(butylene adipate/butylene terephthalate) aliphatic-aromatic copolyester, as defined in claim 5, wherein it is used for manufacturing injected packages for food products, injected packages for cosmetics, tubes, technical pieces and several injected products.

16. Use of the polymeric blend, comprising polyhydroxybutyrate, poly(butylene adipate/butylene terephthalate) aliphatic-aromatic copolyester, as defined in claim 6, wherein it is used for manufacturing injected packages for food products, injected packages for cosmetics, tubes, technical pieces and several injected products.

17. Use of the polymeric blend, comprising polyhydroxybutyrate, poly(butylene adipate/butylene terephthalate) aliphatic-aromatic copolyester, as defined in claim 7, wherein it is used for manufacturing injected packages for food products, injected packages for cosmetics, tubes, technical pieces and several injected products.

18. Use of the polymeric blend, comprising polyhydroxybutyrate, poly(butylene adipate/butylene terephthalate) aliphatic-aromatic copolyester, as defined in claim 8, wherein it is used for manufacturing injected packages for food products, injected packages for-cosmetics, tubes, technical pieces and several injected products.

19. Use of the polymeric blend, comprising polyhydroxybutyrate, poly(butylene adipate/butylene terephthalate) aliphatic-aromatic copolyester, as defined in claim 9, wherein it is used for manufacturing injected packages for food products, injected packages for-cosmetics, tubes, technical pieces and several injected products.
